(19) United States
(12) Patent Application Publication
(10) Pub. No.: US 2016/0261319 A1
(43) Pub. Date: Sep. 8, 2016

(54) CHANNEL ESTIMATION FOR BONDED CHANNELS

(71) Applicant: QUALCOMM Incorporated, San Diego, CA (US)

(72) Inventor: Amichai SANDEROVICH, Atlit (IL)

(21) Appl. No.: 15/056,221

(22) Filed: Feb. 29, 2016

Related U.S. Application Data
(60) Provisional application No. 62/128,865, filed on Mar. 5, 2015.

(51) Int. Cl. H04B 7/04; H04L 27/26

(52) U.S. Cl. CPC H04B 7/0417; H04L 27/2695

(57) ABSTRACT

Certain aspects of the present disclosure provide methods for performing channel estimation of a bonded channel (across multiple channels). An example method includes obtaining a frame received on a bonded channel formed by a plurality of channels, the frame having a plurality of channel estimation training sequences associated with the plurality of channels; generating an aggregated channel estimate for the bonded channel based on the channel estimation training sequences associated with each of the plurality of channels; and processing the frame based on the aggregated channel estimate.

### CROSS-REFERENCE TO RELATED APPLICATIONS

This application claims priority to U.S. Provisional Patent Application Ser. No. 62/128,865, filed Mar. 5, 2015, entitled “Channel Estimation for Bonded Channels,” and assigned to the assignee hereof, the contents of which are hereby incorporated by reference.

### FIELD

Certain aspects of the present disclosure generally relate to wireless communications and, more particularly, to performing channel estimation for bonded channels.

### BACKGROUND

In order to address the issue of increasing bandwidth requirements demanded for wireless communications systems, different schemes are being developed to allow multiple user terminals to communicate with a single access point by sharing the channel resources while achieving high data throughputs. Multiple-input multiple-output (MIMO) technology represents one such approach that has recently emerged as a popular technique for next generation communication systems. MIMO technology has been adopted in several emerging wireless communications standards, such as the Institute of Electrical and Electronics Engineers (IEEE) 802.11 standard. The IEEE 802.11 standard denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}=min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In wireless networks with a single Access Point (AP) and multiple user stations (STAs), concurrent transmissions may occur on multiple channels toward different stations, both in the uplink and downlink direction. Many challenges are present in such systems.

### SUMMARY

Certain aspects of the present disclosure provide an apparatus for wireless communications. The apparatus generally includes an interface for obtaining a frame received on a bonded channel formed by a plurality of channels, the frame having a plurality of channel estimation training sequences associated with each of the plurality of channels; and a processing system configured to generate a channel estimate for the bonded channel based on the channel estimation training sequences associated with each of the plurality of channels and process the frame based on the aggregated channel estimate.

Certain aspects of the present disclosure provide a method for wireless communications by an apparatus. The method generally includes obtaining a frame via a bonded channel formed by a plurality of channels, the frame having a plurality of channel estimation training sequences, each of the channel estimation sequences being associated with at least one of the plurality of channels, generating an aggregated channel estimate for the bonded channel based on the channel estimation training sequences, and processing the frame based on the aggregated channel estimate.

Certain aspects of the present disclosure provide an apparatus for wireless communications. The apparatus generally includes means for obtaining a frame via a bonded channel formed by a plurality of channels, the frame having a plurality of channel estimation training sequences, each of the channel estimation sequences being associated with at least one of the plurality of channels, means for generating an aggregated channel estimate for the bonded channel based on the channel estimation training sequences, and means for processing the frame based on the aggregated channel estimate.

Certain aspects of the present disclosure provide a computer program product for wireless communications by an apparatus. The computer program product generally includes a computer readable medium having instructions stored thereon for obtaining a frame via a bonded channel formed by a plurality of channels, the frame having a plurality of channel estimation training sequences, each of the channel estimation sequences being associated with at least one of the plurality of channels, generating an aggregated channel estimate for the bonded channel based on the channel estimation training sequences, and processing the frame based on the aggregated channel estimate.

Certain aspects of the present disclosure provide a wireless station. The wireless station generally includes at least one antenna, a receiver for receiving, via the at least one antenna on a bonded channel formed by a plurality of channels, the frame having a plurality of channel estimation training sequences, each of the channel estimation sequences being associated with at least one of the plurality of channels, and a processing system configured to generate an aggregated channel estimate for the bonded channel based on the channel estimation training sequences and process the frame based on the aggregated channel estimate.

Aspects of the present disclosure also provide various methods, means, and computer program products corresponding to the apparatuses and operations described above.

### BRIEF DESCRIPTION OF THE DRAWINGS

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 illustrates example operations that may be performed by a wireless device in accordance with certain aspects of the present disclosure.

FIG. 3A illustrates example means capable of performing the operations illustrated in FIG. 3.

FIGS. 4-5 illustrate example frame formats and transmission on multiple channels, in accordance with certain aspects of the present disclosure.

FIG. 6 illustrates an example block diagram of channel estimation of a bonded channel, in accordance with certain aspects of the present disclosure.

FIG. 7 illustrates an example frame format for transmitting data on an individual channel in a bonded channel, in accordance with aspects of the present disclosure.

FIG. 8 illustrates an example frame format for transmitting data on multiple channels in a bonded channel, in accordance with aspects of the present disclosure.

FIG. 9 illustrates an example frame format for transmitting data on a bonded channel with transmission on multiple channels and gaps between channels, in accordance with certain aspects of the present disclosure.

FIG. 10 illustrates an example block diagram of channel estimation of a bonded channel with transmission on channels and gaps between channels, in accordance with aspects of the present disclosure.

FIG. 11 illustrates an example channel estimation for each of a plurality of channels in a bonded channel, in accordance with aspects of the present disclosure.

### DETAILED DESCRIPTION

Aspects of the present disclosure provide techniques for performing channel estimation of a bonded channel formed by bonding a plurality of channels by using channel estimation training sequences transmitted in each of the plurality of channels.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

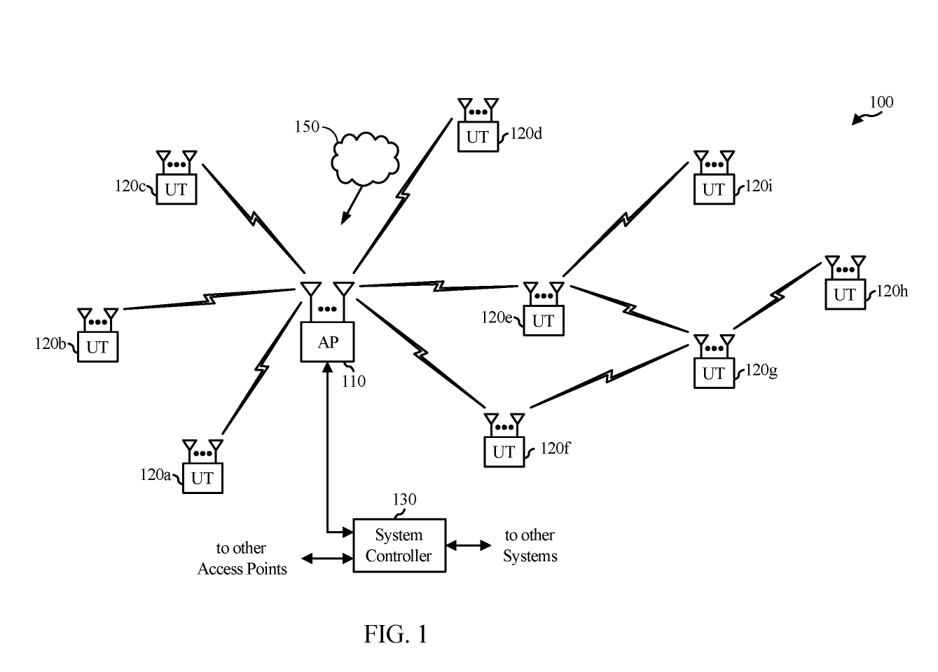

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

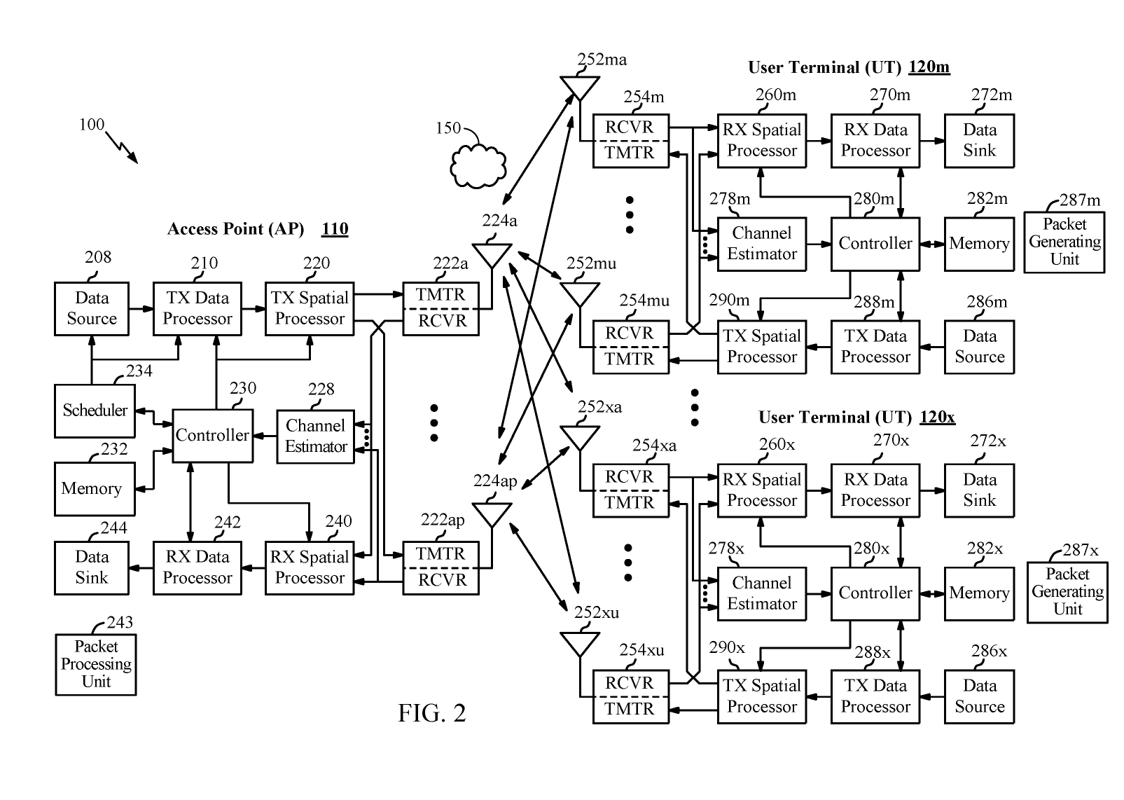

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m}transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides Ndn downlink data symbol streams for the Ndn user terminals. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

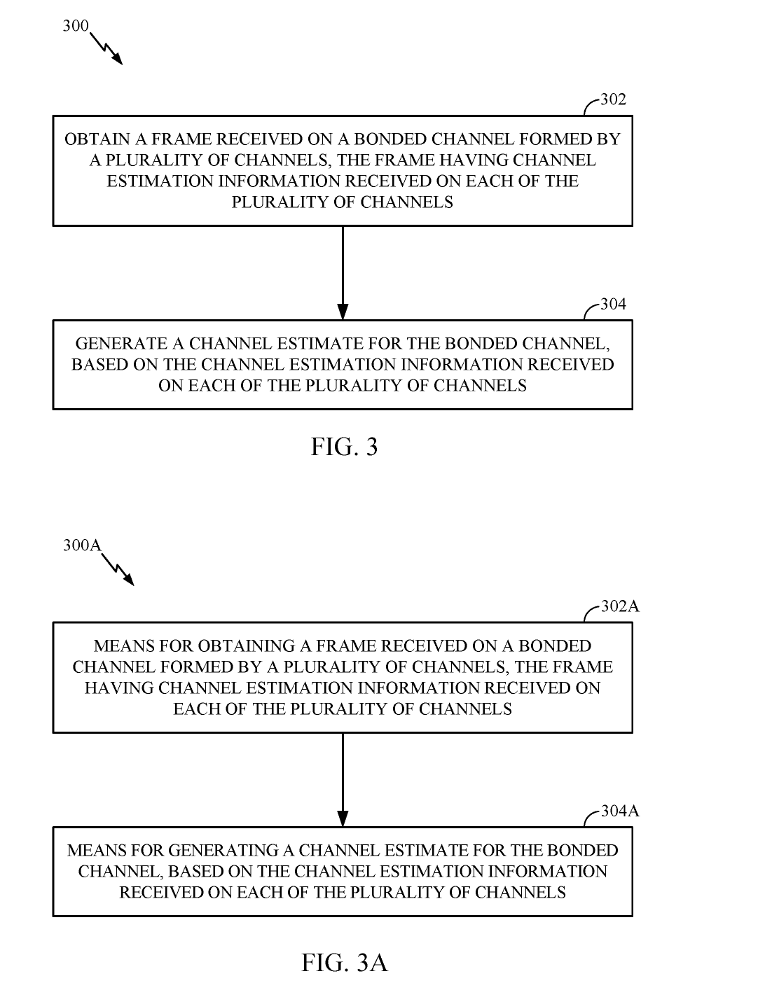

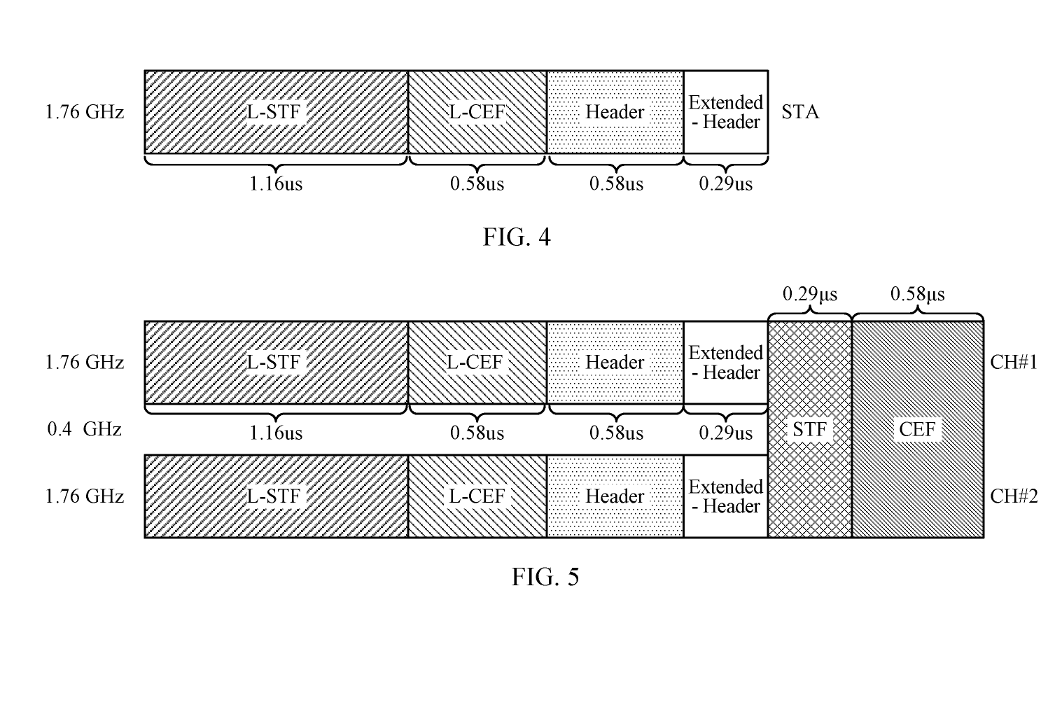

As illustrated, in FIGS. 1 and 2, one or more user terminals 120 may send one or more High Efficiency WLAN (HEW) packets 150, with a preamble format as described herein (e.g., in accordance with one of the example formats shown in FIGS. 3A-4), to the access point 110 as part of a UL MU-MIMO transmission, for example. Each HEW packet 150 may be transmitted on a set of one or more spatial streams (e.g., up to 4). For certain aspects, the preamble portion of the HEW packet 150 may include tone-interleaved LTFs, subband-based LTFs, or hybrid LTFs (e.g., in accordance with one of the example implementations illustrated in FIGS. 4-5 and 7-9).

The HEW packet 150 may be generated by a packet generating unit 287 at the user terminal 120. The packet generating unit 287 may be implemented in the processing system of the user terminal 120, such as in the TX data processor 288, the controller 280, and/or the data source 286.

After UL transmission, the HEW packet 150 may be processed (e.g., decoded and interpreted) by a packet processing unit 243 at the access point 110. The packet processing unit 243 may be implemented in the process system of the access point 110, such as in the RX spatial processor 240, the RX data processor 242, or the controller 230. The packet processing unit 243 may process received packets differently, based on the packet type (e.g., with which amendment to the IEEE 802.11 standard the received packet complies). For example, the packet processing unit 243 may process a HEW packet 150 based on the IEEE 802.11 HEW standard, but may interpret a legacy packet (e.g., a packet complying with IEEE 802.11a/b/g) in a different manner, according to the standards amendment associated therewith.

### Example Channel Estimation for Bonded Channels

Aspects of the present disclosure provide techniques for performing channel estimation on bonded channels. The techniques may be used, for example, in systems where stations capable of transmitting on multiple channels (e.g., double/triple/quadruple 802.11 bands) coexist with legacy devices (e.g., devices capable of only communicating in a single band).

One approach (e.g., for 802.11n and 802.11ac and 802.11ax STAs), is to send preamble information (e.g., the preambles, sequences (e.g., channel estimation sequences), and data that are sent before the station transmits multi-channel data), in all single channels overlapping the multi-channel. Since several estimations are required to enable operations on the multi-channel, STAs generally send additional preamble, sequences (e.g., channel estimation sequences), and header data using the double channel (known as HT-STF and VHT-STF and HT-LTF and VHT-LTF in 802.11n and 802.11ac respectively).

FIG. 3 illustrates example operations 300 that may be performed by a device for generating a channel estimate for a bonded channel, in accordance with certain aspects of the present disclosure. Operations 300 may be performed by an apparatus, such as a STA (e.g., user terminal 120). Operations 300 may begin at 302, where a receiving device obtains a frame on a bonded channel. The bonded channel may be formed by a plurality of channels. The frame may have a plurality of separate channel estimation training sequences (or other sequences) received on each of the plurality of channels. At 304, the receiver may generate a channel estimate for the bonded channel based on the channel estimation training sequences received on each of the plurality of channels.

In some cases, the channel estimation training sequences on each of the plurality of channels may include a sequence of Golay sequences. In some cases, the channel estimation training sequences may include complementary sequences of codes.

FIG. 4 illustrates an example preamble structure that may be used for transmissions without MIMO or channel bonding. As illustrated, the preamble structure may maintain some legacy (e.g., IEEE 802.11ad) preamble features. For example, as illustrated, the preamble structure may include legacy Short Training Fields (L-STFs), channel estimation information (e.g., a channel estimation sequence in a legacy channel estimation field, (L-CEF)), and legacy header information. Maintaining some legacy preamble features may allow for better collision protection (by legacy and non-legacy devices).

As illustrated, the preamble structure may additionally include extended header information, for example, to allow for new modes. While the header information may include information used to demodulate the data, and the header information may be demodulated by all stations in range. The extended header may include additional information that is used only for the receiving station.

As illustrated in FIG. 5, a similar structure may be utilized for frames transmitted with channel bonding. In this case, legacy preambles, which may include L-STF, L-CEF, and legacy headers may be transmitted on each channel, with extended headers, followed by a wider channel STF and CEF (due to the channel bonding). The STF and CEF that follow the headers may be new (e.g., non-legacy) sequences. As illustrated, a channel estimation sequence may be transmitted on each channel, and a channel estimation sequence need not be transmitted in gaps between the channels.

A channel estimate for a bonded channel may be generated based on channel estimates for the individual channels comprising the bonded channel.

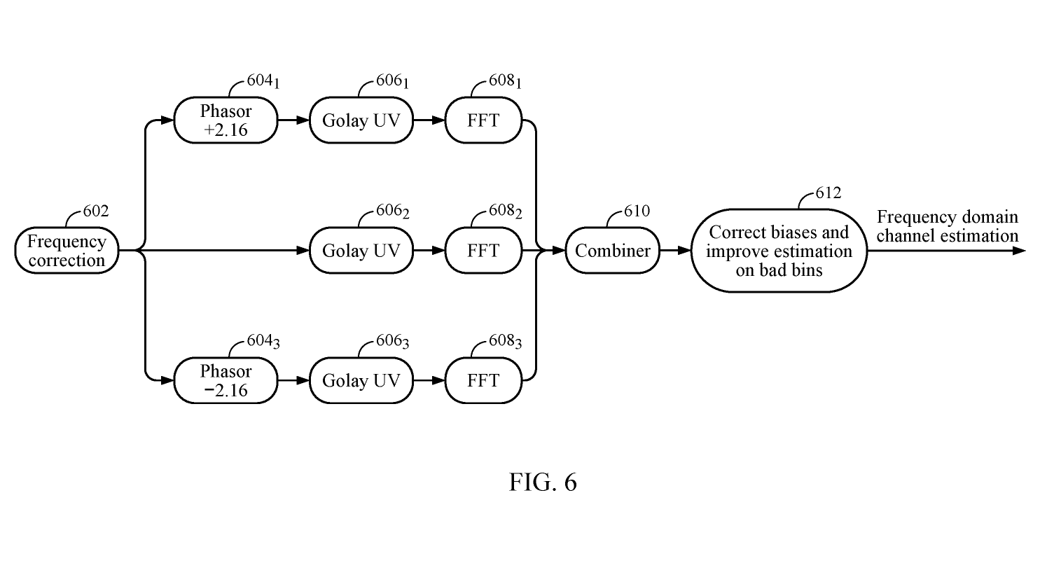

FIG. 6 illustrates an example processing flow diagram for channel estimation of a bonded channel, in accordance with aspects of the present disclosure. As illustrated, channel estimation may be performed independently for each of the channels in the bonded channel. Signals carried on one channel may be considered to have been transmitted on the “baseband”, and a frequency correction (or modulation) 602 may be applied to signals carried on the other channels in the bonded channel. The frequency correction (modulation) may be performed in digital or analog domains.

After applying frequency correction 602 to the channels in the bonded channel, the data (e.g., the channel estimation information, such as complementary Golay sequences) transmitted on channels other than the “baseband” channel may be modulated. To bring these signals into phase with the signal transmitted on the “baseband” channel, a frequency correction 604 may be applied to the signals transmitted on channels other than the “baseband” channel. The phase-corrected channel estimation training sequences may be processed. For example, given, as illustrated, complementary Golay sequences Gu and Gv, the complementary Golay sequences may be processed at a Golay correlator 606 and, in some cases, a fast Fourier transform (FFT) 608 may be applied to the processed Golay sequences to generate a channel estimation for an individual channel.

Each of the individual channel estimates may be combined at combiner 610 to generate a channel estimate for the bonded channel. Additional processing 612 may be performed to correct for errors or biases in the combined channel estimate. As illustrated, the output may be a channel estimation in the frequency domain.

In some cases, channel estimation of the bonded channel can be performed in the time domain. As with performing channel estimation of the bonded channel in the frequency domain, as discussed above, channel estimation may be performed independently for each of the channels in the bonded channel. Channel estimation for each of the channels may be performed in the bonded channel time domain, and the channel estimates for each of the channels may be combined to generate a channel estimate of the bonded channel in the time domain.

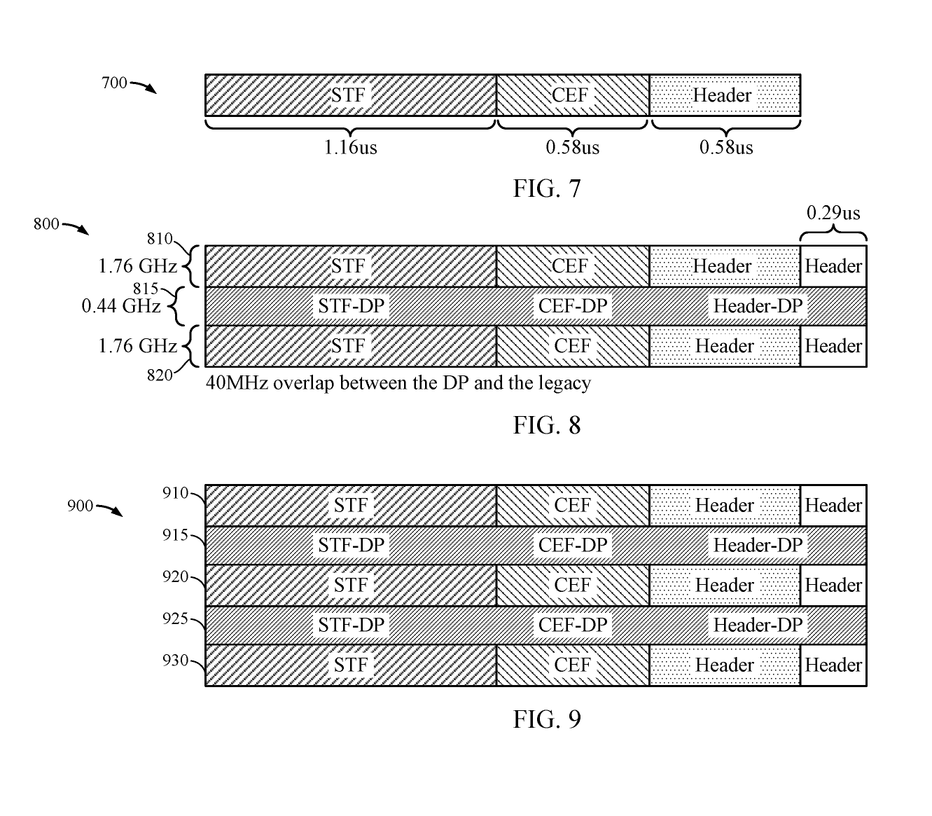

FIGS. 7-9 illustrate example frame formats that may be used to carry sequences and data used, for example, in estimating a bonded channel, in accordance with aspects of the present disclosure.

FIG. 7 illustrates an example preamble structure 700 that may be used for transmissions on a single channel. As illustrated, the preamble structure 700 may maintain some legacy (e.g., IEEE 802.11ad) preamble features, for example, with L-STFs, L-CEFs, and L-Header information. This may allow for better collision protection (by legacy and non-legacy devices).

As illustrated in FIGS. 8 and 9, a similar preamble structure may be used for frames transmitted with channel bonding. FIG. 8 illustrates an example of a bonded channel 800 comprising two channels 810 and 820. As illustrated, in FIG. 8, a single gap 830 may exist between channel 810 and channel 820. An additional channel estimation training sequence may be transmitted in gap 830 between channel 810 and channel 820.

FIG. 9 illustrates an example of a bonded channel comprising three channels 910, 920, and 930. A first gap 915 may exist between channels 910 and 920, and a second gap 925 may exist between channels 920 and 930. Additional channel estimation training sequences and/or other data may be included in transmissions on gaps 915 and 925 between channels 910, 920, and 930. In general, for a transmission on n channels, additional information could be transmitted in n-1 gaps.

As illustrated in FIGS. 8 and 9, assuming a channel bandwidth of 1.76 GHz, the additional information may be transmitted in a 0.44 GHz gap (e.g., in gaps approximately ¼ the size of each of the channels). As illustrated, the additional information may include a short training field (STF) and/or a channel estimation field (CEF). As shown, the frame may also include subsequent header information, decodable by the second type of device, occupying the same channels as the first preamble information.

As illustrated, the remaining portion comprises at least one of a short training field (STF) spanning the plurality of channels and a channel estimation field (CEF) spanning the plurality of channels. A receiving station may decode a data portion of the remaining portion of the frame, based, at least in part, on the STF and CEF fields spanning the plurality of channels.

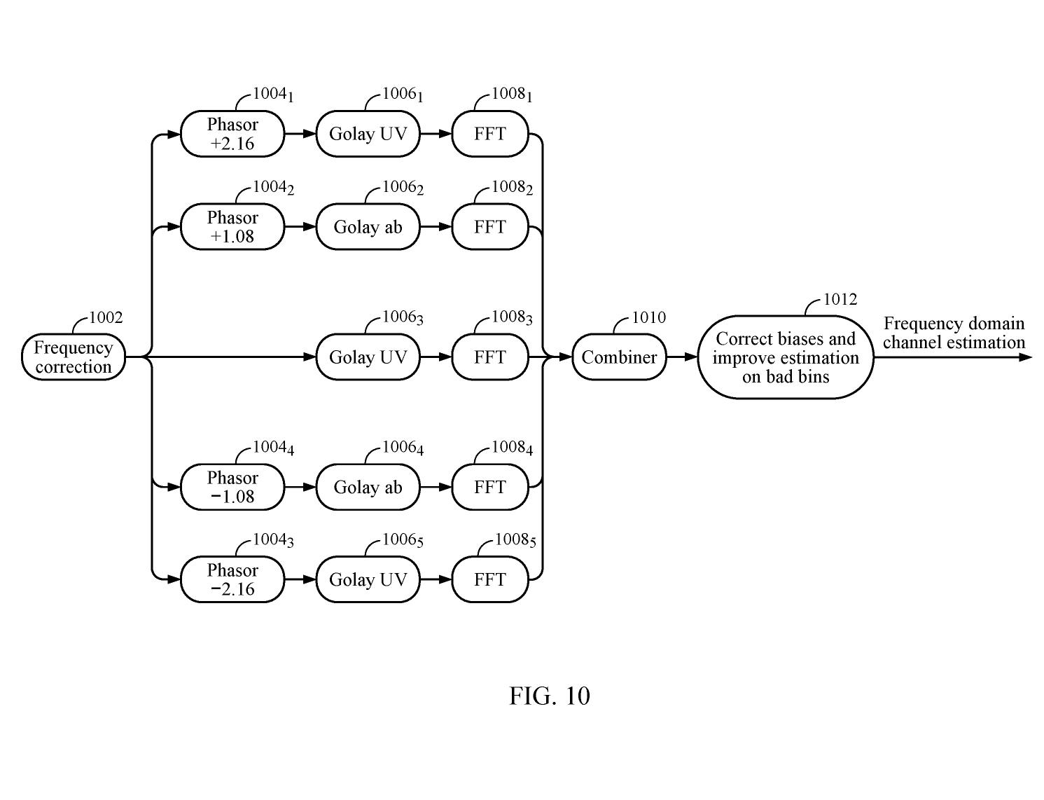

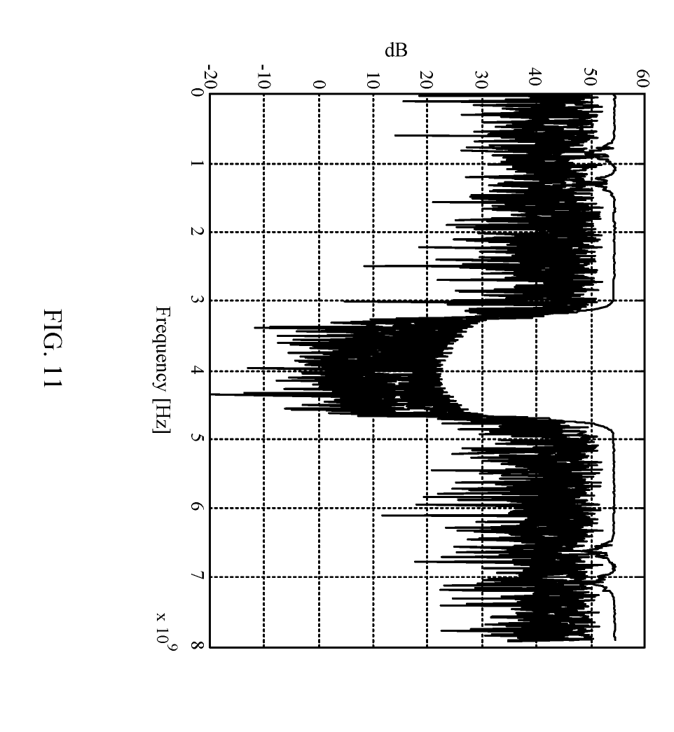

FIG. 10 illustrates an example process flow diagram for channel estimation of a bonded channel, in accordance with aspects of the present disclosure. As illustrated, channel estimation may be performed independently for each of the channels in the bonded channel as well as for information transmitted in gaps between the channels. Like the bonded channel discussed in FIG. 6, signals carried on one channel may be considered to have been transmitted on the “baseband.” To obtain channel estimates for each of the channels in the bonded channel and the gaps between channels, a frequency correction 1002 may be applied to each of the channels. Subsequently, a frequency correction 1004 may be applied to each of the channels other than the “baseband” channel to bring the signals transmitted on each of the channels into phase with the signals transmitted on the “baseband” channel.

As illustrated, different sequences may be transmitted on the channels and in the gaps between channels. For example, Golay sequences Gu and Gv may be transmitted on the individual channels in the bonded channel. Meanwhile, Golay sequences Ga and Gb may be transmitted in gaps between the channels. Because Golay sequences Ga and Gb are transmitted in gaps between the channels (e.g., in the 0.4 GHz gaps separating different 1.76 GHz channels, as discussed above), Golay sequences Ga and Gb may have a shorter length than Golay sequences Gu and Gv.

Based on the phase-corrected signals on each of the channels and the gaps between the channels, channel estimations may be performed on each of the channels and the gaps between the channels. The channel estimations may be generated by processing the Golay sequences on each channel and the gaps between channels at a Golay correlator 1006 and applying an FFT 1008 to the processed Golay sequences. The resulting individual channel estimations for the channels and gaps may be demodulated and combined at combiner 1010 into a single channel estimate for the bonded channel. Further processing 1012 may be applied to the single channel estimate to improve the channel estimate (e.g., by correcting for errors or biases on the channels). For example, if, as illustrated in FIG. 8, transmissions on a 0.4 GHz gap are performed with a bandwidth of 0.44 GHz, further processing may be applied to account for the overlap in the frequency domain (e.g., the 0.04 GHz overlap between a transmission on a gap and a channel).

FIG. 11 illustrates an example graph showing the results of channel estimation for each channel in the bonded channel and for the gaps between channels in the bonded channels. As discussed above, a channel estimate for the bonded channel may be generated based on the channel estimates generated for the individual channels (and optionally on the estimates generated for the gaps between channels in the bonded channel).

### Example Phase Tracking for Transmissions on Bonded Channels

In some cases, the sequences (e.g., Golay sequences or other channel estimation sequences) described above may be transmitted in a preamble, as pilot symbols, or as training fields at the end of a frame. These sequences may be processed, for example, to track the locations of stations connected to an access point using the preambles, for beamforming, (which configures the phase shifters to obtain a good antenna pattern using the training fields at the end of a frame), and for phase and channel tracking during the data payload using pilot sequences.

The signals carried on one channel in a bonded channel are received out-of-phase relative to signals carried on another channel in a bonded channel. To perform phase tracking and configure the phase shifters the same training fields may be transmitted on multiple channels (e.g., on two bands). One channel may be considered the “baseband” channel, and frequency correction can be performed on the channels other than the “baseband” channel, as discussed above. Based on the corrected channels, a station can compare signals carried on the “baseband” channel and signals carried on a channel other than the “baseband” channel. The phase difference determined from the comparison of the signals can be used to configure the phase correction applied to the signals carried on the channel other than the baseband channel before further processing is performed (e.g., combining channels).

In some cases, phase differences between different channels may result from the use of different antennas to receive signals on different channels in the bonded channel. The phase differences may result, for example, from different distances that signals travel before being received by different antennas (or different sectors of an antenna) at a station. By designating one channel as a “baseband” channel and the other channels in the bonded channel as non-baseband channels, a station can examine and compare phase differences at different antennas. By comparing phase differences at different antennas, the station can adjust phase shifters for one or more channels to compensate for phase differences that may result from different signal arrival times at different antennas.

In another example, a receiver can estimate the location of a transmitter based on the time of arrival of the signal. In order to accurately estimate the time of arrival of the signal, the receiver processes the channel estimations generated based on the preambles transmitted on the bonded channels, as described above. After performing phase correction on the preambles, the receiver can use an FFT and estimate the arrival time with a high precision using the combined channel estimates of the channels at the edges of the bonded channel.

In another example, a receiver can estimate the phase of the signals using pilot sequences that are embedded in a data transmission. For example, Golay sequences used in 802.11ad can be used as pilots. These pilots may be transmitted on individual channels which are aggregated into a single transmission on a bonded channel. The receiver can use the techniques described herein to accurately estimate the phase offset due to imperfect oscillators and perform phase correction on the pilots based on the estimated phase offset.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 300 illustrated in FIG. 3 means 300A illustrated in FIG. 3A.

For example, means for transmitting (or means for outputting for transmission) may comprise a transmitter (e.g., the transmitter unit 222) and/or an antenna(s) 224 of the access point 110 or the transmitter unit 254 and/or antenna(s) 252 of the user terminal 120 illustrated in FIG. 2. Means for receiving (or means for obtaining) may comprise a receiver (e.g., the receiver unit 222) and/or an antenna(s) 224 of the access point 110 or the receiver unit 254 and/or antenna(s) 254 of the user terminal 120 illustrated in FIG. 2. Means for processing, means for generating, means for performing frequency offset adjustment, or means for determining, may comprise a processing system, which may include one or more processors, such as the RX data processor 242, the TX data processor 210, the TX spatial processor 220, and/or the controller 230 of the access point 110 or the RX data processor 270, the TX data processor 288, the TX spatial processor 290, and/or the controller 280 of the user terminal 120 illustrated in FIG. 2.

In some cases, rather than actually transmitting a frame, a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
an interface for obtaining a frame via a bonded channel formed by a plurality of channels, the frame having a plurality of channel estimation training sequences, each of the channel estimation sequences being associated with at least one of the plurality of channels; and
a processing system configured to generate an aggregated channel estimate for the bonded channel based on the channel estimation training sequences and process the frame based on the aggregated channel estimate.

2. The apparatus of claim 1, wherein each of the channel estimation training sequences comprises a Golay sequence.

3. The apparatus of claim 1, wherein the processing system is configured to generate the aggregated channel estimate for the bonded channel by:
generating an individual channel estimate for each of the plurality of channels, based on the channel estimation training sequences; and
generating the aggregated channel estimate for the bonded channel based on the individual channel estimates.

4. The apparatus of claim 3, wherein the processing system is configured to generate the individual channel estimates in frequency domain and generate the aggregated channel estimate for the bonded channel in frequency domain.

5. The apparatus of claim 3, wherein the processing system is configured to generate the individual channel estimate for each of the plurality of channels by:
modulating, in frequency domain, signals received via the plurality of channels, the signals comprising at least one of the channel estimation training sequences; and
generating the individual channel estimate for each of the plurality of channels based on the modulated received signals.

6. The apparatus of claim 5, wherein the modulation is performed by the processing system in digital or analog domain.

7. The apparatus of claim 3, wherein the generation of the individual channel estimates is performed by the processing system in time domain.

8. The apparatus of claim 3, wherein the processing system is configured to process the individual channel estimates in frequency domain to correct biases.

9. The apparatus of claim 1, wherein the processing system is further configured to:
compare a phase of a first sequence transmitted in a first of the plurality of channels with a phase of a second sequence transmitted in a second of the plurality of channels; and
adjust the phase of the second sequence based on the comparison.

10. A method for wireless communications by an apparatus, comprising:
obtaining a frame via a bonded channel formed by a plurality of channels, the frame having a plurality of channel estimation training sequences, each of the channel estimation sequences being associated with at least one of the plurality of channels;
generating an aggregated channel estimate for the bonded channel based on the channel estimation training sequences; and
processing the frame based on the aggregated channel estimate.

11. The method of claim 10, wherein each of the channel estimation training sequences comprises a Golay sequence.

12. The method of claim 10, wherein generating the aggregated channel estimate comprises:
generating an individual channel estimate for each of the plurality of channels, based on the channel estimation training sequences; and
generating the aggregated channel estimate for the bonded channel based on the individual channel estimates.

13. The method of claim 12, wherein the individual channel estimates are generated in frequency domain and the aggregated channel estimate for the bonded channel is generated in frequency domain.

14. The method of claim 12, wherein generating the individual channel estimate for each of the plurality of channels comprises:
modulating, in frequency domain, signals received via each of the plurality of channels, the signals comprising at least one of the channel estimation training sequences; and
generating the individual channel estimate for each of the plurality of channels based on the modulated received signals.

15. The method of claim 14, wherein the modulation is performed by the processing system in digital or analog domain.

16. The method of claim 12, wherein generating the individual channel estimates is performed in time domain.

17. The method of claim 12, further comprising processing the individual channel estimates in frequency domain to correct biases.

18. The method of claim 10, further comprising:
comparing a phase of a first sequence transmitted in a first of the plurality of channels with a phase of a second sequence transmitted in a second of the plurality of channels; and
adjusting the phase of the second sequence based on the comparison.

19.-28. (canceled)

29. A wireless station, comprising:
at least one antenna;
receiver configured to receive, via the at least one antenna on a bonded channel formed by a plurality of channels, the frame having a plurality of channel estimation training sequences, each of the channel estimation sequences being associated with at least one of the plurality of channels; and
a processing system configured to generate an aggregated channel estimate for the bonded channel based on the channel estimation training sequences and process the frame based on the aggregated channel estimate.
